(19) United States
(12) Patent Application Publication
(10) Pub. No.: US 2014/0289181 A1
(43) Pub. Date: Sep. 25, 2014

(54) Knowledge Reasoning Method of Boolean Satisfiability (SAT)

(71) Applicants: Sherwin Han, Portsmouth, RI (US); Cuifeng Zhou, Santa Clara, CA (US)

(72) Inventors: Sherwin Han, Portsmouth, RI (US); Cuifeng Zhou, Santa Clara, CA (US)

(21) Appl. No.: 14/087,380

(22) Filed: Nov. 22, 2013

Related U.S. Application Data
(63) Continuation of application No. 13/188,122, filed on Jul. 21, 2011, now abandoned.
(60) Provisional application No. 61/400,880, filed on Aug. 4, 2010.

(51) Int. Cl. G06N 5/02

(52) U.S. Cl. CPC G06N 5/022
USPC 706/46

(57) ABSTRACT

Disclosed is a knowledge reasoning method for solving Boolean Satisfiability problems. This method is one of the applications of the method disclosed in the US patent “Knowledge Acquisition and Retrieval Apparatus and Method” (U.S. Pat. No. 6,611,841). Disclosed method applies learning function to access iterative set relations among variables, literals, words and clauses as knowledge; And applies deduction and reduction functions to retrieve relations as reasoning. The process is a knowledge learning (KL) and knowledge reasoning algorithm (KRA). KRA abandons the “OR” operation of Boolean logic and processes only set relations of the data. The novelty of the disclosed method is the reversibility between the deduction and reduction. That is, KRA of Boolean Satisfiability applies a pair of perceptual-conceptual languages to learn member-class relations and retrieve information through deductive and reductive reasoning.

### FIELD OF THE INVENTION

The present invention relates generally to solving the problem of Boolean Satisfiability, and more particularly to a method that applies knowledge learning and reasoning technology to solve Boolean Satisfiability problems in linear time.

### BACKGROUND OF THE INVENTION

Boolean Satisfiability (SAT) is a problem that has both academic and practical significance. In the industry domain the methodology of solution is used to prove the correctness of digital logic circuits and for many other purposes. Numerous solution algorithms have been proposed and implemented, however, none of them is able to reach a polynomial-time efficiency. The present invention provides such a polynomial, more accurately, linear-time efficiency methodology of solving Boolean satisfiability problems.

### SUMMARY OF THE INVENTION

The present invention is a method of solving Boolean Satisfiability (SAT) problem that employs a patented knowledge learning (KL) and cognitive logic reasoning (CLR) technology. The significance of this invention is its linear-time efficiency solution to this well-known problem.

The knowledge learning technology contains a pair of hierarchical mirrored languages as its data structure. SAT formula is converted to its complement conjunction form and learned as element-class relations among its classes of variables, literals, words and clauses. The method and system of the present invention employs a patented deduction and reduction method to retrieve the element-class relations of the data between the mirrored languages.

The method and system abandons the “OR” operation and recognizes what are the data that are not satisfiable and delete them from the knowledge domain. The method and system of the present invention provides the remaining of the knowledge domain as a countable range of assignments.

### BRIEF DESCRIPTION OF THE DRAWINGS

A more complete understanding of the invention will be readily appreciated as the same becomes better understood by reference to the following detailed description when considered in conjunction with the accompanying drawing:

FIG. 1 presents the relations among variables, literals, words, and clauses

FIG. 2 presents the relations among 2-variable combinations, words, and clauses

FIG. 3 presents the rules of rejection recognition

FIG. 4 presents the 3-dimensional correlate system as the domain of 3-SAT

FIG. 5 presents 1-2 rule of literal rejection

FIG. 6 presents 2-2 rule of literal rejection

FIG. 7 presents 3-3=2 rule of word rejection

FIG. 8 presents 2-2-3 rule of word rejection

FIG. 9 presents 3-3-2 rule of word rejection

FIG. 10 presents 3-3-3-3 rule of word rejection

### DETAILED DESCRIPTION OF THE INVENTION

Elimination of OR Operator Method

The present knowledge reasoning method applies a patented knowledge acquisition and retrieval method disclosed in the US patent “Knowledge Acquisition and Retrieval Apparatus and Method” (U.S. Pat. No. 6,611,841) by the same inventor Sherwin Han. Knowledge reasoning method converts the disjunction of the literals of the formula clauses to its semantic equivalent conjunction of literals, and eliminates OR operators. Each 3SAT formula contains m disjunctive clauses, and each disjunctive clause can be represented by a set of eight conjunctive clauses including one complement. For example, disjunctive clause (xₓ [symbol] x₂ [symbol] ˜x₃) can be presented by a set of eight conjunctive clauses {(x₁ [symbol] x₂ [symbol] x₃), (x₁ [symbol] x₂ [symbol] ˜x₃), x₁ [symbol] ˜x₂ [symbol] x₃), (x₁ [symbol] ˜x₂ [symbol] ˜x₃), (˜x₁ [symbol] x₂ [symbol] x₃), (˜x₁ [symbol] x₂ [symbol] ˜x₃), (˜x₁ [symbol] ˜x₂ [symbol] x₃), (˜x₁ [symbol] ˜x₂ [symbol] ˜x₃)} in which (˜x₁ [symbol] ˜x₂ [symbol] x₃) is a complement of (x₁ [symbol] x₂ [symbol] ˜x₃). Clause (x₁ [symbol] x₂ [symbol] ˜x₃) means that (˜x₁ [symbol] ˜x₂ [symbol] x₃) is not satisfiable, and the rest of conjunctive clauses are satisfiable. Elimination of OR operator simplifies and unifies the information processing and enables reversibility of knowledge information.

Knowledge Base Method

The present knowledge reasoning method organizes SAT formula information as five levels of classes and the relations among them iteratively. The five levels from top to bottom are formula, clause, word, literal and variable. Each formula contains a countable size of clauses.

Each clause contains three words. For example, clause (˜x₁ [symbol] ˜x₂ [symbol] x₃) contains three words (˜x₁ [symbol] ˜x₂) (˜x₁ [symbol] x₃) and (˜x₂ [symbol] x₃) as its elements. Each word belongs to multiple clauses. Each word contains two literals as its elements, and each literal belongs to 2n−2 words. Each literal contains one variable and its value as its elements. Let us use a SAT formula (˜1 [symbol] ˜2 [symbol] ˜3) (˜1 [symbol] ˜2 [symbol] 3) (˜1 [symbol] ˜2 [symbol] ˜4) (˜1 [symbol] 4 [symbol] 5) (˜2 [symbol] 3 [symbol] ˜5) as an example to describe the iterative relations:

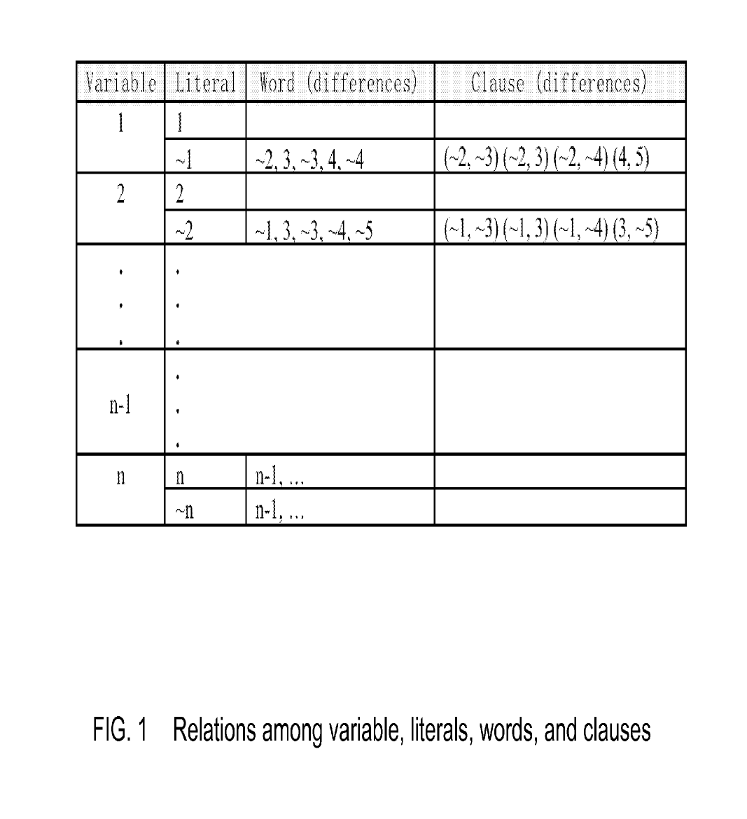

Referring FIG. 1, the variable-literal relation level contains relations between variables and literals, wherein the elements of the literal class are variables and their values. N variables belong to 2N literals. Each variable belongs to two complement literals. The relation between literals and their variable elements are in sequence order in the knowledge base.

The literal-word relation level contains relations between literals and words, wherein the elements of the word class are literals. Each word contains two literals, and belongs to multiple clauses. Each two variables can combine to four words. The relations among literals, 2-variable combinations, and words are in sequence order in the knowledge base.

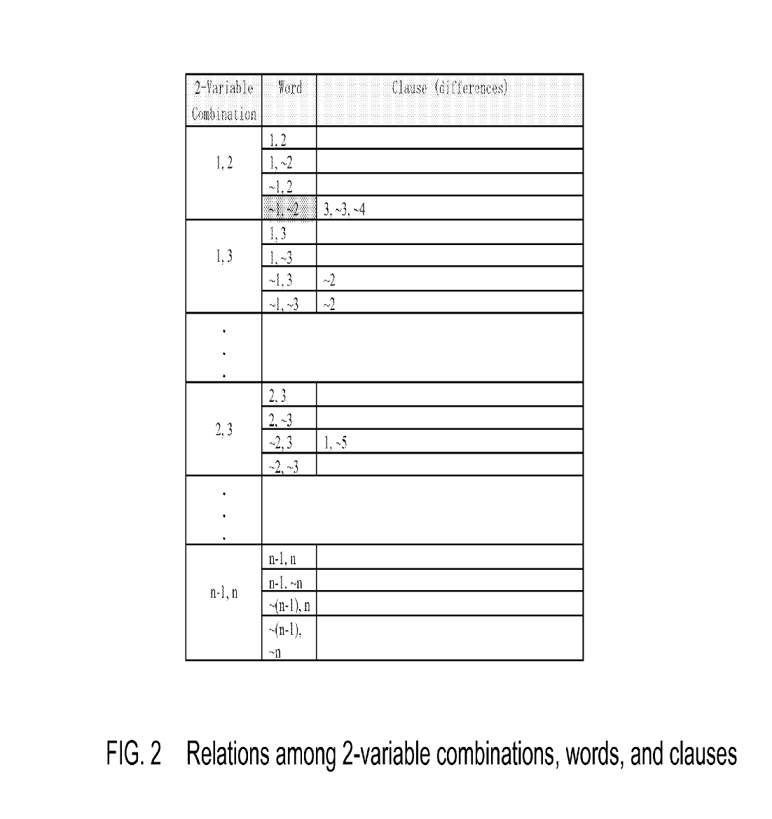

Referring FIG. 2, the word-clause relation level contains relations between words and clauses, wherein the elements of clause class are words. Each clause contains three words. Each word belongs to multiple clauses. The relations between words and clauses are in sequence order in the knowledge base.

Referring FIGS. 1 and 2, SAT formula information is learned and organized as iterative element-class relations in a bi-directional retrievable knowledge base. Deductive retrieval function is to retrieve class information from the given element information. Reductive retrieval function is to retrieve element information from the given class information.

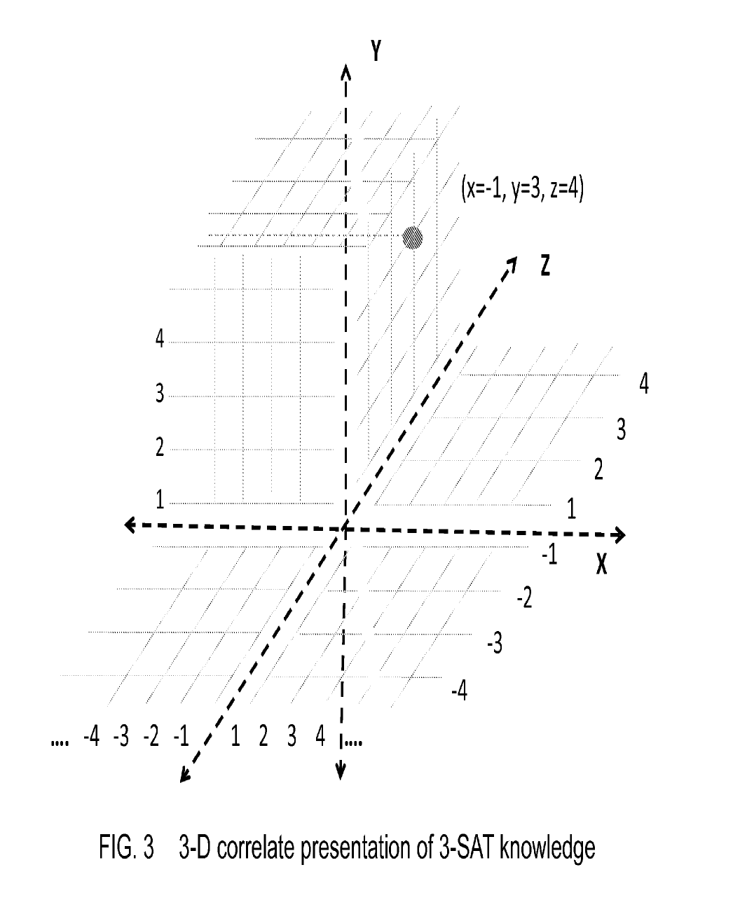

Referring FIG. 3, SAT formula information is processed in a domain of a 3-dimensional coordinate system, wherein each 3-dimensional coordinate represents a clause; each 2-dimensional coordinate represents a word; and each 1-dimensional coordinate represents a literal. Each pair of complementary literals represents two values of a variable.

One of the novelties of the present method is to reject all the unsatisfied elements of the domain and leave the remains of the domain as the range of the assignments. That is, the present method recognizes all the clauses, words, literals, and variables that are not satisfiable to the formula and reject them. If any two values of a variable are rejected, then the formula has no assignment; otherwise, the formula has at least one assignment. The assignment is the union of the words remaining. If multiple words remain, the formula has multiple assignments.

Knowledge Reasoning Method

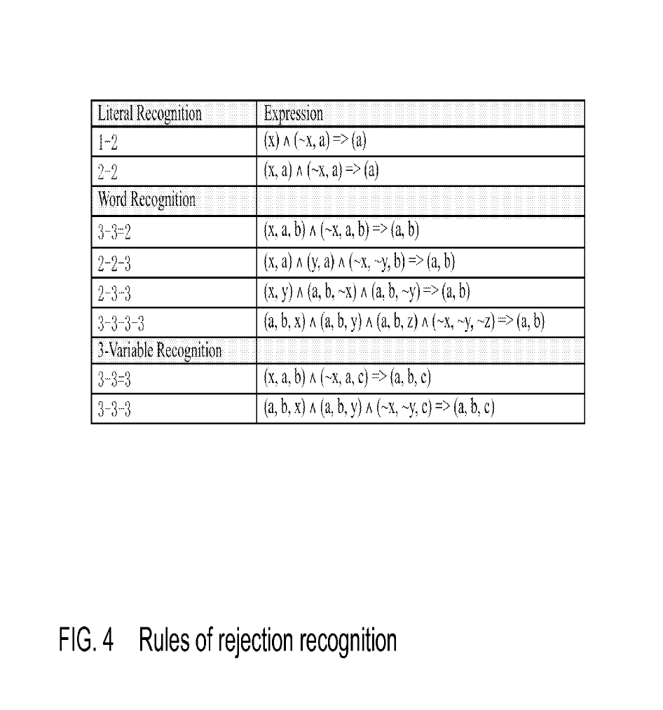

Referring FIG. 4, the present knowledge reasoning method is to recognize what the elements of the formula should be rejected. The reasoning functions are deduction and reduction. The deduction reasoning is to recognize relations from a given element level to the class level. The reduction reasoning is to recognize relations from a given class level to the element level. Each time unsatisfied elements are rejected new relationship can be recognized back and forth by deductive and reductive reasoning. Due to these invert functions, the iterative relations among the formula, clauses, words, literals and variables can be processed from top level to bottom level, and from the bottom level to top level in linear time. The detailed procedures of rejections are described as following:

Rules of Rejection Method

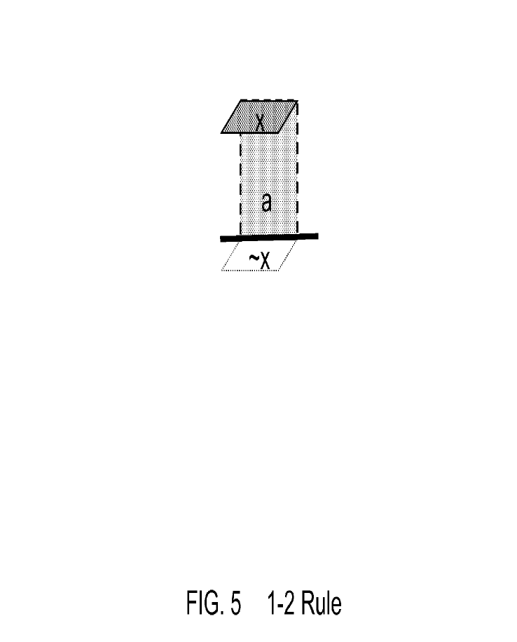

Referring FIG. 5, 1-2 literal rejection rule is stated:

The literal (a) is rejected if a rejected literal (x) is complement to the literal (˜x) of a rejected word (˜x, a).

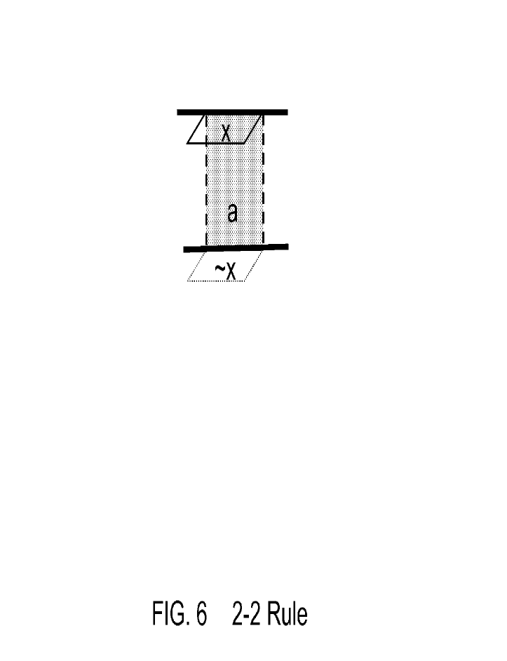

Referring FIG. 6, 2-2 literal rejection rule is stated:

The literal (a) is rejected if (a) is an intersection of two rejected words (x, a) and (˜x, a), and the differences (x) and (˜x) are complement to each other.

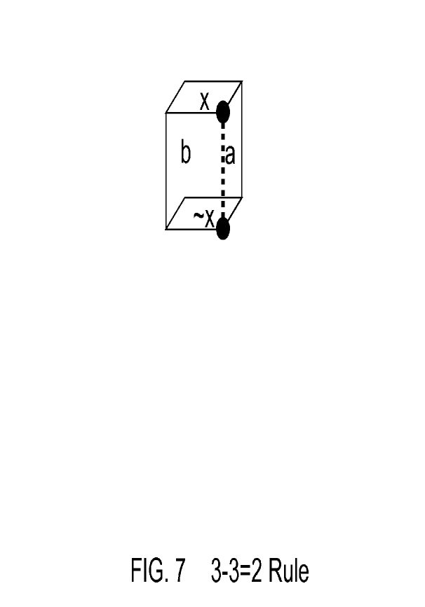

Referring FIG. 7, 3-3 word rejection rule is stated:

The word (a, b) is rejected if one literal (x) of one rejected clause (x, a, b) is a complement to the literal (˜x) of the other rejected clause (˜x, a, b), and the word (a, b) is an intersection.

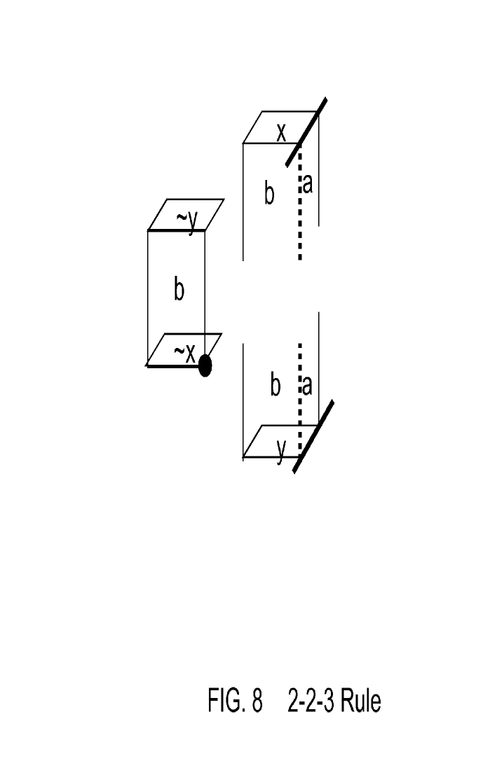

Referring FIG. 8, 2-2-3 word rejection rule is stated:

The word (a, b) is rejected if one literal (x) of one rejected word (x, a) and one literal (y) of another rejected word (y, a) are complements to the literals (˜x) and (˜y) of a rejected clause (˜x, ˜y, b), and the literal (a) is an intersection of the two word.

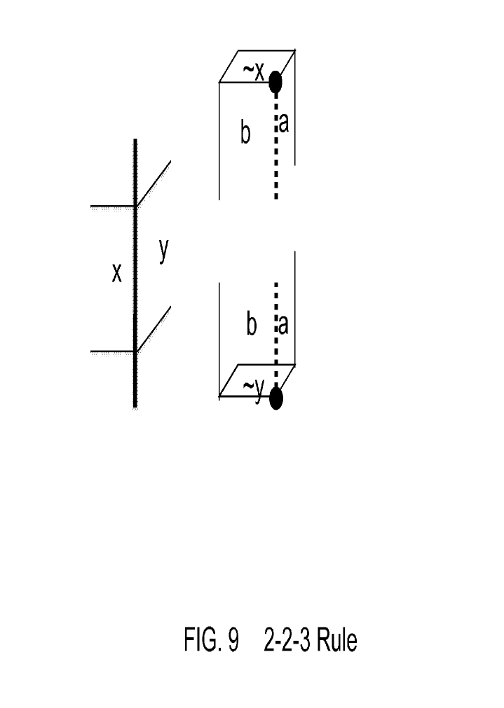

Referring FIG. 9, 2-3-3 word rejection rule is stated:

The word (a, b) is rejected if two literals (x) and (y) of one rejected word (x, y) are complements to the literal (˜x) and (˜y) of two rejected clauses (a, b, ˜x) and (a, b, ˜y), and the word (a, b) is an intersection of the two clauses.

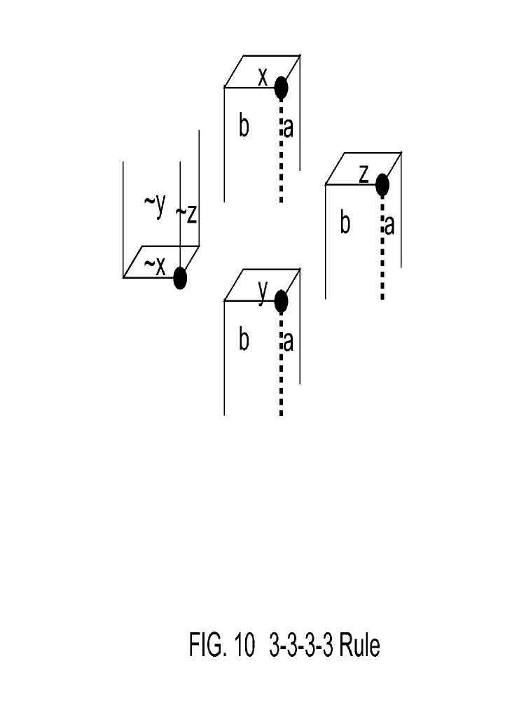

Referring FIG. 10, 3-3-3-3 word rejection rule is stated: The word (a, b) is rejected if three literal (x), (y), and (z) of three rejected clauses (a, b, x), (a, b, y), and (a, b, z) are complements to the literals (˜x), (˜y), and (˜z) of a rejected clause (18 x, ˜y, ˜z), and the word (a, b) is an intersection of the three clauses.

Referring FIG. 2, if three or more words in one set of 2-variable combinations are the intersections of three or more clauses, we call them crucial-values due to its potential rejections of words. The present knowledge reasoning method processes these data first to optimize the procedure.

Although the present invention has been described in a very simple way, this invention provides a very clear cut and revolutionary solution to a well-known problem for which there has been no solution until now. Any modifications or alterations to this invention should be included within the scope of this invention.

1. A knowledge reasoning method for determining if satisfying variable assignments of Boolean formulas exist, or to find errors in or prove the design correctness of software programs or hardware circuit, the method consist of a patented knowledge acquisition and retrieval system disclosed in the US patent “Knowledge Acquisition. and Retrieval Apparatus and Method” (U.S. Pat. No. 6,611 ,841).

2-7. (canceled)
